(19) United States
(12) Patent Application Publication
(10) Pub. No.: US 2014/0218732 A1
(43) Pub. Date: Aug. 7, 2014

(54) PARTICLE COUNTER TESTING METHOD, AEROSOL GENERATING DEVICE, AND AEROSOL GENERATING METHOD

(71) Applicant: Azbil Corporation, Tokyo (JP)

(72) Inventor: Shinsuke YAMASAKI, Tokyo (JP)

(73) Assignee: Azbil Corporation, Tokyo (JP)

(21) Appl. No.: 14/174,069

(22) Filed: Feb. 6, 2014

(30) Foreign Application Priority Data
Feb. 6, 2013 (JP) 2013-021530

(51) Int. Cl. B65D 83/14; G01N 15/06

(52) U.S. Cl. CPC B65D 83/752; G01N 15/06
USPC 356/337; 222/635; 222/1

(57) ABSTRACT

A particle counter testing method includes the steps for storing particles in a container, blowing a compressed gas through an inlet flow path, through a wall of the container, into the particles that are stored within the container, spraying the particles that are blown by the compressed gas to outside of the container through a nozzle that is provided on the container, and measuring the number of particles by a particle counter. In the method, an outer shape of the nozzle is a conical shape. The compressed gas is blown into the container through an inlet flow path so that a pressure of a sprayed aerosol gas flow that includes particles is lower than a pressure of a surrounding gas.

### CROSS REFERENCE TO RELATED APPLICATION

This application claims priority under 35 U.S.C. §119 to Japanese Patent Application No. 2013-021530, filed on Feb. 6, 2013, the entire content of which being hereby incorporated herein by reference.

### FIELD OF TECHNOLOGY

The present invention relates to an environment evaluating technology, and, in particular, relates to a particle counter testing method, an aerosol generating device, and an aerosol generating method.

### BACKGROUND

In, for example, clean rooms in semiconductor manufacturing factories, the quantity of particles suspended in air within the clean rooms is monitored using a particle detecting device. In evaluating the particle capturing performance of particle detecting devices, the correspondence between the quantity of particles dispersed in the air within the test environment and the results of detection by the particle detecting device is examined. At this time, it is desirable to be able to control accurately the quantity of particles dispersed in the air in the test environment. See, for example, Japanese Unexamined Patent Application Publication No. 2004-159508, Japanese Unexamined Patent Application Publication No. 2008-22764, Japanese Unexamined Patent Application Publication No. 2008-22765 and US Patent Application Publication No. 2011/0132108.

The present inventor, as the result of earnest research, discovered that when airborne particles aggregate, the particle sizes become irregular, making it impossible to evaluate accurately the counting capability, such as the counting efficiency of a particle counter. Given this, an aspect of the present invention is to provide a particle counter testing method able to evaluate accurately the counting capability of a particle counter, an aggregate particle dispersing aerosol generating device, and an aerosol generating method.

### SUMMARY

A form of the present invention provides a particle counter testing method wherein: (a) particles are stored in a container; (b) a compressed gas is blown through an inlet flow path, through a wall of the container, into the particles that are stored within the container; (c) the particles that are blown by the compressed gas are sprayed to the outside of the container through a nozzle that is provided on the container; and (d) the number of particles is measured by a particle counter; wherein: (e) the outer shape of the nozzle is a conical shape; and (f) the compressed gas is blown into the container through an inlet flow path so that the pressure of the sprayed aerosol gas flow that includes particles is lower than the pressure of the surrounding gas.

Moreover, a form of the present invention provides an aerosol generating device, including: (a) a container that sotres particles; (b) an inlet flow path for a compressed gas that passes through a wall of the container, where a compressed gas is blown into the particles that are stored within the container; (c) a nozzle that has a conical outer shape, provided on the container, for spraying to the outside the particles that are blown by the compressed gas; and (d) a compressor that feeds compressed gas into the container through an inlet flow path so that the pressure of the sprayed aerosol gas flow that includes particles is lower than the pressure of the surrounding gas. The compressor, for example, feeds the compressed gas into the container so as to draw the surrounding gas toward the low-pressure gas flow that includes particles, so as to produce turbulent flow. Moreover, the compressor, for example, feeds the compressed gas into the container so as to break down, by the turbulent flow, particles that are aggregated. Doing so causes agitation of the particles by the turbulent flow, breaking down aggregated particles.

Moreover, a form of the present invention provides a method for generating an aerosol wherein: (a) particles are stored in a container; (b) a compressed gas is blown through an inlet flow path, through a wall of the container, into the particles that are stored within the container; and (c) the particles that are blown by the compressed gas are sprayed to the outside of the container through a nozzle wherein the outer shape of the nozzle is a conical shape and that is provided on the container; wherein: (d) the compressed gas is said into the container through an inlet flow path so that the pressure of the sprayed aerosol gas flow that includes particles is lower than the pressure of the surrounding gas.

The present invention enables the provision of a particle counter testing method able to evaluate accurately the counting capability of a particle counter, an aggregate particle dispersing aerosol generating device, and an aerosol generating method.

### BRIEF DESCRIPTIONS OF THE DRAWINGS

FIG. 1 is a schematic diagram of an aerosol generating device according to Example according to the present invention.

FIG. 2 is a schematic diagram of a nozzle according to the Example according to the present invention.

FIG. 3 is a perspective diagram viewing the test chamber in Another Example according to the present invention from the side.

FIG. 4 is a schematic diagram of a nozzle according to a comparative example in the present invention.

### DETAILED DESCRIPTION

Examples of the present invention will be described below. In the descriptions of the drawings below, identical or similar components are indicated by identical or similar codes. Note that the diagrams are schematic. Consequently, specific measurements should be evaluated in light of the descriptions below. Furthermore, even within these drawings there may, of course, be portions having differing dimensional relationships and proportions.

### Example

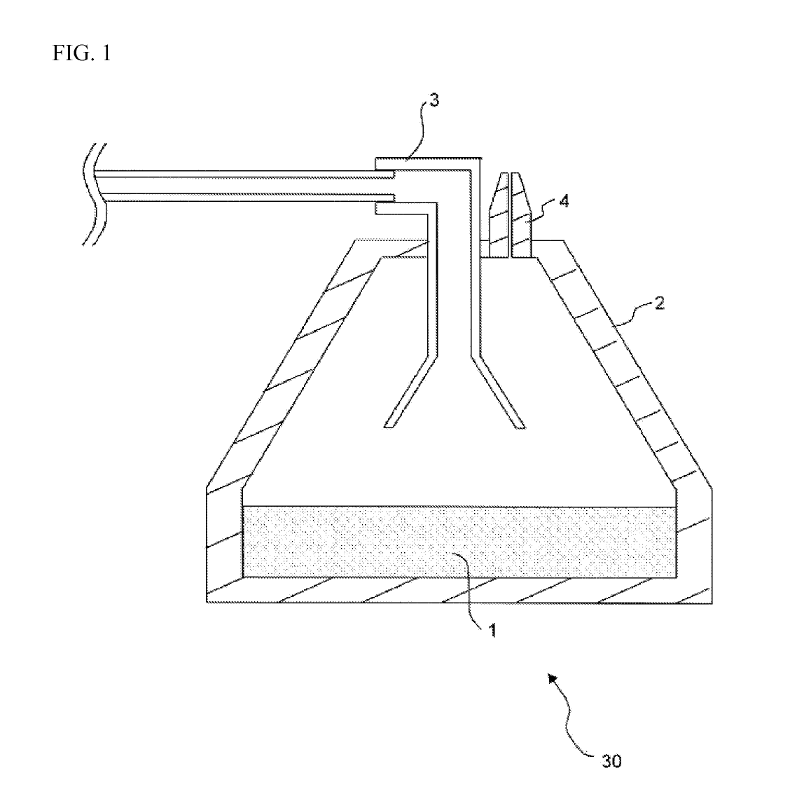

As illustrated in FIG. 1, the aerosol generating device 30 according to Example includes: a container 2 that contains particles 1; an inlet flow path 3 for a compressed gas, which passes through a wall of the container 2, for blowing the particles 1 that are stored in the container 2 into the compressed gas; a nozzle 4 that has a conical outer shape, provided in the container 2, for spraying, to outside of the container 2, the particles 1 that have been blown into the flow of the compressed gas; and a compressor that feeds a compressed gas to the container 2 through the inlet flow path 3 so that the pressure of the aerosol gas flow that includes the particles that have been sprayed is relatively less than the pressure of the surrounding gas.

While the diameters of the particles 1 are, for example, between 1 and 4 μm, there is no limitation thereto. The particles 1 are dry. The container 2 is made from a metal, or the like, that can withstand high pressures. The inlet flow path 3 is a pipe, where the tip portion that faces the particles 1 that are stored in the container 2 spreads out in a conical shape. In other words, the opening of the end part of the inlet flow path 3 spreads out in a trumpet shape. The end part (end portion) of the inlet flow path 3 spreading in a trumpet shape, results in the tendency for the number of particles included in the aerosol that is sprayed from the nozzle 4 to be constant. The inlet flow path 3 is also made from a metal, or the like, that can withstand high pressures. The nozzle 4 is provided with a through hole with a diameter of, for example, 1 mm. A plurality of through holes may be provided in a ring shape in the cross-section of the nozzle 4, for example. The nozzle 4 is also made from a metal, or the like, that can withstand high pressures. A jet nozzle or a spray nozzle, for example, may be used for the nozzle 4.

When the compressed gas blows the particles 1 from the trumpet-shaped opening of the inlet flow path 3, the particles within the container 2 are picked up by the compressed gas. Moreover, the gas pressure within the container 2 is increased. Because of this, an aerosol that includes the particles within the container 2 is sprayed out from the nozzle 4. Because the gas pressure within the container 2 is higher than the gas pressure outside of the container 2, and the diameter of the through hole of the nozzle 4 is small, the aerosol sprays at a high speed from the nozzle 4. The flow rate of the gas flow of the aerosol is, for example, between 40 and 100 m/sec.

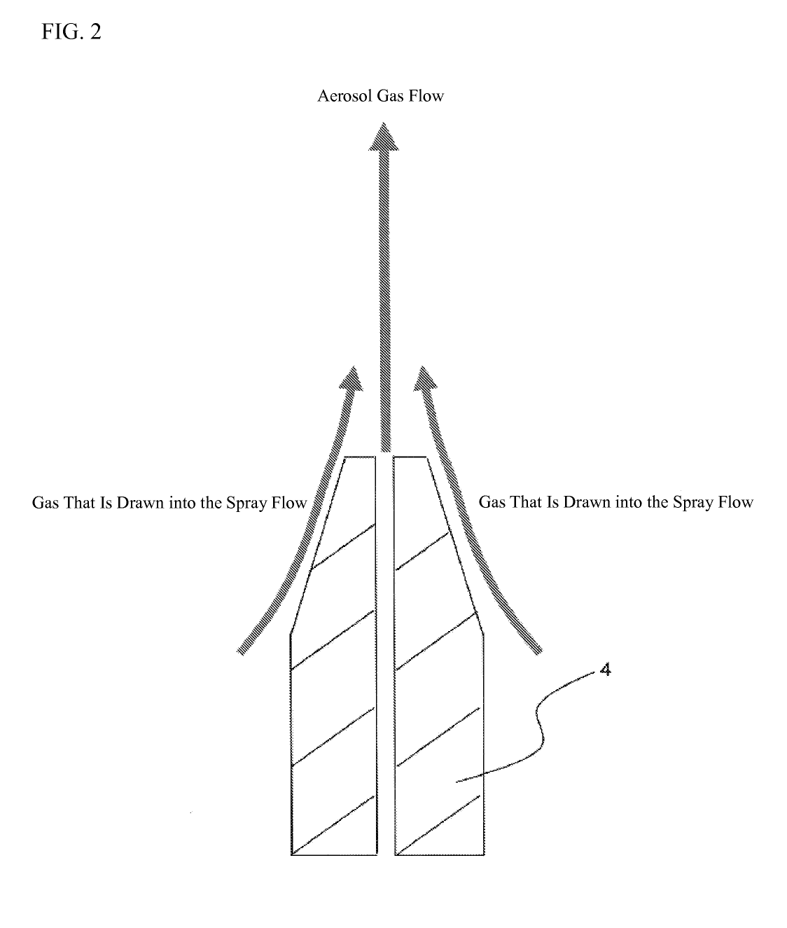

The pressure of the high-speed gas flow of the aerosol is low when compared to the pressure of the surrounding gases, and thus, as illustrated in FIG. 2, the surrounding gases are drawn toward the low-pressure gas flow that includes the particles. Moreover, because the external shape of the nozzle 4 is conical, the surrounding gas is efficiently drawn toward the high-speed airflow of the aerosol along the side faces of the nozzle 4. This drawing of the surrounding gas increases the volume of the high-speed gas flow of the aerosol, causing it to disperse. Moreover, the surrounding gas being drawn toward the high-speed gas flow of the aerosol produces a turbulent flow. When aggregated particles are included in the aerosol, the aggregated particles are agitated by the turbulent flow and broken down, producing a monodispersive system for the aerosol.

### Another Example

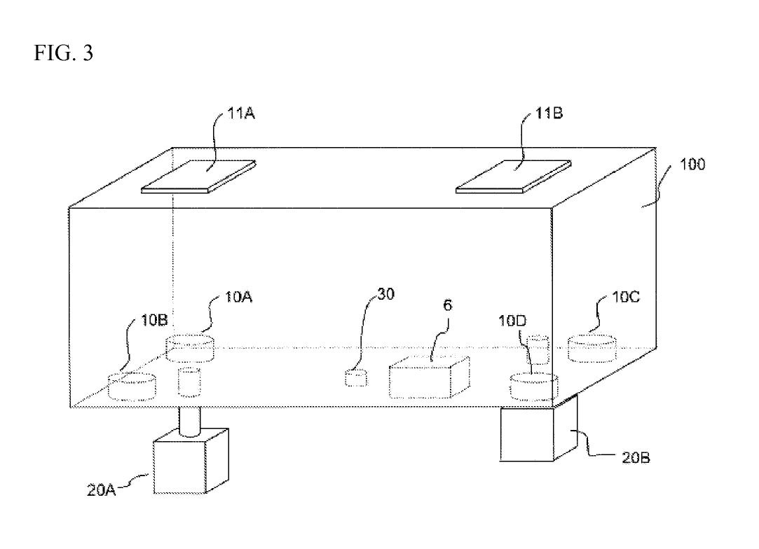

A particle counter testing method according to Another Example is performed in a test chamber 100 as illustrated in FIG. 3, for example. The test chamber 100 is a chamber that is provided with, for example, an aluminum frame and transparent panels, made from polycarbonate, fitted into the frame to serve as sidewalls. Note that the form of the test chamber 100 may be a duct, or the like. The interior volume of the test chamber 100 is, for example, 3 m³, but there is no limitation thereto. The test chamber 100 is provided with, for example, air supplying devices 11A and 11B, for example. The air supplying devices 11A and 11B supply, into the test chamber 100, clean air through ultrahigh performance air filters such as HEPA filters (High Efficiency Particulate Filters) or ULPA filters (Ultra Low Penetration Air Filters), or the like. A door may be provided in a sidewall of the test chamber 100.

An aerosol generating device 30 as described in the Example is disposed in the center bottom of the test chamber 100. As described in the Example, the aerosol generating device 30 generates an aerosol through a simple dispersion system. Agitating fans 10A, 10B, 10C, and 10D are disposed as agitating devices within the test chamber 100. The agitating fans 10A through 10D agitate the gas, such as air, within the test chamber 100, to prevent natural settling, by their own weight, of the particles that are dispersed into the air within the test chamber 100.

Moreover, an air cleaner 6, as a cleaning device, is disposed within the test chamber 100. The air cleaner 6 removes particles that are included in the gas, such as air, or the like, within the test chamber 100, to clean the gas. For example, prior to spraying the a gas flow of the aerosol that contains the particles into the test chamber 100 from the aerosol generating device 30, the air cleaner 6 can be run to remove in advance, from within the test chamber 100, any particles other than the particles that are included in the aerosol that is to be sprayed from the aerosol generating device 30. Note that while in FIG. 3 the air cleaner 6 is disposed on the bottom surface within the test chamber 100, the air cleaner 6 may instead be disposed on a wall or the ceiling of the test chamber 100.

Moreover, the test chamber 100 is provided with a suction opening for a reference particle counter 20A and a suction opening for a particle counter 20B that is subject to testing. The reference particle counter 20A and the particle counter 20B that is subject to testing each draw in gas from within the test chamber 100, and illuminate with light the airborne particles that are included in the gas, to detect the scattered light produced by the particles, to thereby measure the diameters, quantities, concentrations, and the like, of the airborne particles based on the scattered light that is detected. The reference particle counter 20A is calibrated so as to count all particles of diameters that are near to the minimum diameter of the particles that can be counted by the particle counter 20B that is subject to testing. Here the counting efficiency of the particle counter 20B that is subject to testing is calculated as the ratio of the concentration of particles counted by the particle counter 20B that is subject to testing relative to the concentration of particles counted by the reference particle counter 20A. The particle concentration is defined as the number of particles per cubic meter, for example.

When testing the measurement efficiency of the particle counter 20B that is subject to testing, the particles of particle diameters that are near to the minimum particle diameters of the particles that can be counted by the particle counter 20B that is subject to testing, and particles of particle diameters that are between 1.5 times and 2 times the minimum particle diameter are used. Here the present inventor, as the result of earnest research, discovered that aggregated particles are included randomly in an aerosol that is produced through the conventional aerosol generating device, and that the aggregated particles are detected as particles with large particle diameters by the particle counters, thus producing variability in the test results for counting efficiency each time a test is performed. In contrast, the testing method for a particle counter as set forth in the Another Example enables the variability in the particle efficiency tests to be suppressed through the use of the aerosol generating device 30 that breaks down the aggregated particles, as explained in the Example.

### Yet Another Examples

Two particle counters having 0.5 μm channels were prepared. Following this, a test powder 11 according to JIS Z 8901 was stored in an aerosol generating device that has a conical nozzle that is provided with a through hole with a diameter of 1 mm, as explained in the Example. The test powder 11 of JIS Z 8901 includes between 60 and 70% particles with a particle diameter of 1 μm, but also includes aggregated particles. Following this, an aerosol was produced by the aerosol generating device, and the particle diameters were measured 90 times using the two particle counters, at which time the average value for the particle diameters was 1.095239, with a standard deviation for the particle diameter of 0.025347, and a coefficient of variance of 2.3%.

### Comparative Example 1

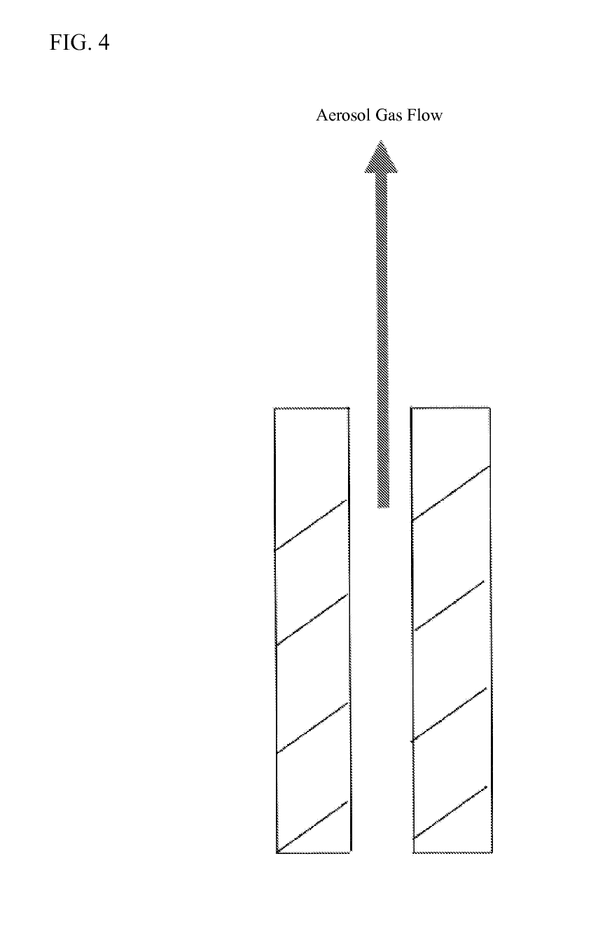

Two particle counters identical to those in the Yet Another Example were prepared. Next, a cylindrical nozzle as illustrated in FIG. 4, rather than one with a conical shape, was provided on the aerosol generating device, with a through hole diameter of 6 mm. The other structures of the aerosol generating device, the pressure of the compressed gas, and the like, were identical to that of Yet Another Example. The same particles as with the Yet Another Example were contained within the aerosol generating device. Following this, an aerosol was produced by the aerosol generating device and the particle diameters were measured 90 times using the two particle counters, at which time the average value for the particle diameters was 1.338692, with a standard deviation for the particle diameter of 0.157516, and a coefficient of variance was 11.8%. Consequently, particles wherein the aggregated particles were not broken down were detected.

### Comparative Example 2

Two particle counters identical to those in the Yet Another Example were prepared. Given this, beads wherein the degree of particulation is high, with essentially no aggregation, and with diameters of 1.0 μm, were stored in an aerosol generating device that was identical to that of the Yet Another Example. Next, an aerosol was produced by the aerosol generating device, and the particle diameters were measured 90 times by the two particle counters, at which time the average value for the particle diameters was 1.1102306, with a standard deviation for the particle diameter of 0.019775, and a coefficient of variance of 1.8%. Given this, was demonstrated that, in the Yet Another Example, the particles that were aggregated were essentially broken down in the aerosol, and that the aggregated particles were eliminated.

While there are descriptions of the examples as set forth above, the descriptions and drawings that form a portion of the disclosure are not to be understood to limit the present invention. A variety of alternate examples and operating technologies should be obvious to those skilled in the art. The present invention should be understood to include a variety of examples, and the like, not set forth herein.

1. A particle counter testing method comprising:
storing particles in a container;
blowing a compressed gas through an inlet flow path, through a wall of the container, into the particles that are stored within the container;
spraying the particles that are blown by the compressed gas to outside of the container through a nozzle that is provided on the container; and
measuring the number of particles by a particle counter, wherein:
an outer shape of the nozzle is a conical shape; and
the compressed gas is blown into the container through an inlet flow path so that a pressure of a sprayed aerosol gas flow that includes particles is lower than a pressure of a surrounding gas.

2. The particle counter testing method as set forth in claim 1, wherein: the compressed gas is blown into the container so as to draw the surrounding gas toward the low-pressure gas flow that includes particles, so as to produce turbulent flow.

3. The particle counter testing method as set forth in claim 2, wherein:
the compressed gas is blown into the container so as to break down, by the turbulent flow, particles that are aggregated.

4. The particle counter testing method as set forth in claim 2, wherein:
the particles are agitated by the turbulent flow.

5. The particle counter testing method as set forth in claim 1, wherein:
the inlet flow path is a pipe; and the end portion of the inlet flow path that faces the particles that are contained spreads into a conical shape.

6. An aerosol generating device, comprising:
a container that stores particles;
an inlet flow path for a compressed gas that passes through a wall of the container, where a compressed gas is blown into the particles that are stored within the container;
a nozzle that has a conical outer shape, provided on the container, for spraying to outside the particles that are blown by the compressed gas; and
a compressor that feeds compressed gas into the container through an inlet flow path so that a pressure of a sprayed aerosol gas flow that includes particles is lower than a pressure of a surrounding gas.

7. The aerosol generating device as set forth in claim 6, wherein:
the compressor feeds the compressed gas into the container so as to draw the surrounding gas toward the low-pressure gas flow that includes particles, so as to produce turbulent flow.

8. The aerosol generating device as set forth in claim 7, wherein:
the compressor feeds the compressed gas into the container so as to break down, by the turbulent flow, particles that are aggregated.

9. The aerosol generating device as set forth in claim 7, wherein:
the particles are agitated by the turbulent flow.

10. The aerosol generating device as set forth in claim 6, wherein:
the inlet flow path is a pipe; and the end portion of the inlet flow path that faces the particles that are contained spreads into a conical shape.

11. An aerosol generating method wherein:
storing particles in a container;
blowing a compressed gas through an inlet flow path, through a wall of the container, into the particles that are stored within the container; and
spraying the particles that are blown by the compressed gas to outside of the container through a nozzle that has a cylindrical outer shape and that is provided on the container, wherein:
the compressed gas is blown into the container through an inlet flow path so that a pressure of a sprayed aerosol gas flow that includes particles is lower than a pressure of a surrounding gas.

12. The aerosol generating method as set forth in claim 11, wherein:
the compressed gas is blown into the container so as to draw the surrounding gas toward the low-pressure gas flow that includes particles, so as to produce turbulent flow.

13. The aerosol generating method as set forth in claim 12, wherein:
the compressed gas is blown into the container so as to break down, by the turbulent flow, particles that are aggregated.

14. The aerosol generating method as set forth in claim 12, wherein:
the particles are agitated by the turbulent flow.

15. The aerosol generating method as set forth in claim 11, wherein:
the inlet flow path is a pipe; and the end portion of the inlet flow path that faces the particles that are contained spreads into a conical shape.
